(19) United States
(12) Patent Application Publication
(10) Pub. No.: US 2007/0111135 A1
(43) Pub. Date: May 17, 2007

(54) Positive resist composition and method of forming resist pattern using same

(75) Inventors: Ryotaro Hayashi, Kawasaki-shi (JP); Masaru Takeshita, Kawasaki-shi (JP); Takeshi Iwai, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOKYO OHKA KOGYO CO., LTD., KANAGAWA-KEN (JP)

(21) Appl. No.: 10/561,830

(22) PCT Filed: Jun. 28, 2004
(86) PCT No.: PCT/JP04/09455

§ 371 Date: Dec. 22, 2005

(30) Foreign Application Priority Data
Jul. 1, 2003 (JP) 2003-189707
Apr. 14, 2004 (JP) 2004-119498

(51) Int. Cl. G03C 1/00

(52) U.S. Cl. 430/270.1

(57) ABSTRACT

A positive resist composition which includes a resin component (A) that exhibits increased alkali solubility under the action of acid, an acid generator component (B) that generates acid on exposure, and an organic solvent (C). The component (A) includes (i) a structural unit (a1), which contains an acid dissociable, dissolution inhibiting group and is derived from a (meth)acrylate ester, (ii) a structural unit (a2), which contains an acid dissociable, dissolution inhibiting group that is less readily dissociated than the acid dissociable, dissolution inhibiting group contained in the structural unit (a1), and is derived from a (meth)acrylate ester, and (iii) a structural unit (a3), which contains a lactone functional group and is derived from a (meth)acrylate ester.

### TECHNICAL FIELD

The present invention relates to a positive resist composition, and a method of forming a resist pattern.

Priority is claimed on Japanese Patent Application No. 2003-189707, filed Jul. 1, 2003, and Japanese Patent Application No. 2004-119498, filed Apr. 14, 2004, the contents of which are incorporated herein by reference.

### BACKGROUND ART

In recent years, the miniaturization of semiconductor elements has continued to progress, and the development of lithography processes that use ArF excimer lasers (193 nm) and the like is being vigorously pursued. As the base resin for chemically amplified resists for use with ArF excimer lasers, resins that exhibit a high level of transparency relative to the ArF excimer laser are preferred.

For example, resins in which the principal chain contains structural units derived from a (meth)acrylate ester containing a polycyclic hydrocarbon group such as an adamantane skeleton at the ester section are attracting considerable attention, and many such resins have already been proposed (see the patent references 1 to 8 listed below).

[Patent Reference 1]

Japanese Patent (Granted) Publication No. 2,881,969

[Patent Reference 2]

Japanese Unexamined Patent Application, First Publication No. Hei 5-346668

[Patent Reference 3]

Japanese Unexamined Patent Application, First Publication No. Hei 7-234511

[Patent Reference 4]

Japanese Unexamined Patent Application, First Publication No. Hei 9-73173

[Patent Reference 5]

Japanese Unexamined Patent Application, First Publication No. Hei 9-90637

[Patent Reference 6]

Japanese Unexamined Patent Application, First Publication No. Hei 10-161313

[Patent Reference 7]

Japanese Unexamined Patent Application, First Publication No. Hei 10-319595

[Patent Reference 8]

Japanese Unexamined Patent Application, First Publication No. Hei 11-12326

However, two of the important parameters required of resist materials used in lithography processes are depth of focus (DOF) and proximity effect.

The depth of focus is the range across which favorable resolution can be obtained even if the exposure focus deviates, and larger values are preferred.

The proximity effect refers to the phenomenon whereby the dimensions and shape of a formed resist pattern are effected by proximate patterns. An increase in the size of the proximity effect causes an undesirable increase in the difference in pattern dimensions for a dense pattern region (a line and space section) and a non-dense pattern region (an isolated pattern section) that have been formed using masks with identical pattern dimensions. This difference in dimensions must be kept as small as possible, meaning it is desirable to reduce the proximity effect.

The present invention takes the above circumstances into consideration, with an object of providing a resist composition and a method of forming a resist pattern that enable the proximity effect to be reduced without reducing the depth of focus.

### DISCLOSURE OF INVENTION

A first aspect of the present invention provides a positive resist composition which includes a resin component (A) that exhibits increased alkali solubility under the action of acid, an acid generator component (B) that generates acid on exposure, and an organic solvent (C), wherein the component (A) includes (i) a structural unit (a1), which contains an acid dissociable, dissolution inhibiting group and is derived from a (meth)acrylate ester, (ii) a structural unit (a2), which contains an acid dissociable, dissolution inhibiting group that is less readily dissociated than the acid dissociable, dissolution inhibiting group contained in the structural unit (a1) and is derived from a (meth)acrylate ester, and (iii) a structural unit (a3), which contains a lactone functional group and is derived from a (meth)acrylate ester.

A second aspect of the present invention is a method of forming a resist pattern, including the steps of applying a positive resist composition according to the first aspect to a substrate, conducting a prebake, performing selective exposure, conducting PEB (post exposure baking), and performing alkali developing to form a resist pattern.

### BEST MODE FOR CARRYING OUT THE INVENTION

As follows is a detailed description of embodiments of the present invention, using a series of examples.

[Positive Resist Composition]

A positive resist composition of the present invention includes a resin component (the component (A)), which contains a structural unit (a1), a structural unit (a2), and a structural unit (a3) described below, and exhibits increased alkali solubility under the action of acid, an acid generator component (the component (B)) that generates acid on exposure, and an organic solvent (the component (C)).

In this positive resist composition, because the action of the acid generated from the component (B) on exposure causes the alkali solubility of the component (A) to increase, by exposing the resist film through a mask pattern, the alkali solubility of the exposed portions can be increased, meaning a resist pattern can then be formed using alkali developing.

Component (A)

Structural Units (a1), (a2)

The structural unit (a1) and the structural unit (a2) are both structural units that are derived from (meth)acrylate esters. The term “(meth)acrylate ester” is a generic term that includes both acrylate ester and methacrylate ester. Similarly, the term (meth)acrylate is a generic term that includes both acrylate and methacrylate.

The structural unit (a1) and the structural unit (a2) both contain an acid dissociable, dissolution inhibiting group, although the acid dissociable, dissolution inhibiting group contained in the structural unit (a2) is less readily dissociated than the acid dissociable, dissolution inhibiting group contained in the structural unit (a1). In other words, the component (A) includes two or more different acid dissociable, dissolution inhibiting groups that exhibit different levels of ease of dissociation (acid dissociability).

When used within a chemically amplified positive resist composition, the acid dissociable, dissolution inhibiting group may be any group that has an alkali solubility inhibiting effect that renders the entire polymer insoluble in alkali prior to exposure, but then dissociates under the action of acid generated from the component (B) following exposure, causing the entire polymer to become alkali soluble. Two groups with different acid dissociability can be selected from amongst the various acid dissociable, dissolution inhibiting groups.

As the acid dissociable, dissolution inhibiting group, typically, groups that form a cyclic or chain-like tertiary alkyl ester with the carboxyl group of the (meth)acrylic acid group are the most widely known.

From the viewpoints of achieving favorable transparency and etching resistance, an acid dissociable, dissolution inhibiting group that contains an aliphatic polycyclic group is preferred. These polycyclic group-containing acid dissociable, dissolution inhibiting groups are ideal for positive resist compositions for use with ArF excimer lasers.

Examples of this polycyclic group include groups in which one hydrogen atom has been removed from a bicycloalkane, tricycloalkane or tetracycloalkane or the like.

Specific examples include groups in which one hydrogen atom has been removed from a polycycloalkane such as adamantane, norbornane, isobornane, tricyclodecane or tetracyclododecane.

These types of polycyclic groups can be appropriately selected from the multitude of groups proposed for polymers (resin components) for use within ArF excimer laser resist compositions.

Of these polycyclic groups, adamantyl groups, norbornyl groups and tetracyclododecanyl groups are preferred from an industrial viewpoint.

Specifically, the structural unit (a1) containing the more readily dissociable acid dissociable, dissolution inhibiting group is preferably at least one unit selected from the general formulas (I) and (II) shown below, whereas the structural unit (a2) containing the less readily dissociable acid dissociable, dissolution inhibiting group is preferably at least one unit selected from the general formulas (III) and (IV) shown below. 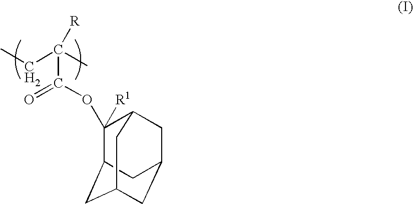
(wherein, R represents a hydrogen atom or a methyl group, and R¹ represents a lower alkyl group of 2 or more carbon atoms) 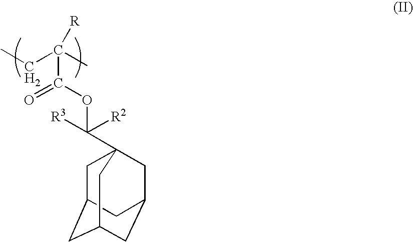
(wherein, R represents a hydrogen atom or a methyl group, and R² and R³ each represent, independently, a lower alkyl group) 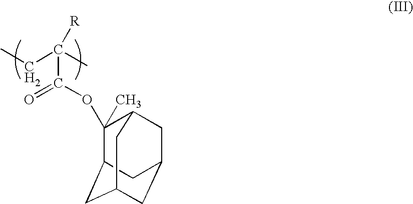
(wherein, R represents a hydrogen atom or a methyl group) 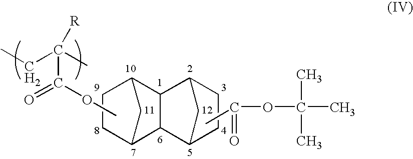
(wherein, R represents a hydrogen atom or a methyl group)

The structural unit represented by the general formula (I) is a (meth)acrylate structural unit with a hydrocarbon group bonded through an ester linkage, and by bonding a straight-chain or a branched alkyl group to the carbon atom of the adamantyl group that is adjacent to the oxygen atom (—O—) of the ester function of the (meth)acrylate structural unit, a tertiary alkyl group is formed within the ring skeleton of the adamantyl group.

In this formula, the group R¹ is preferably a straight-chain or branched lower alkyl group of 2 to 5 carbon atoms, and specific examples include an ethyl group, propyl group, isopropyl group, n-butyl group, isobutyl group, tert-butyl group, pentyl group, isopentyl group and neopentyl group. Of these, an ethyl group is preferred from an industrial viewpoint.

The structural unit represented by the aforementioned general formula (II), like that of the general formula (I), is a (meth)acrylate structural unit with a hydrocarbon group bonded through an ester linkage, although in this case, the carbon atom adjacent to the oxygen atom (—O—) of the ester function of the (meth)acrylate structural unit is a tertiary alkyl group, and a ring skeleton such as an adamantyl group exists within this tertiary alkyl group.

The groups R² and R³ each preferably represent, independently, a lower alkyl group of 1 to 5 carbon atoms.

Specifically, the groups R² and R³ preferably each represent, independently, a straight-chain or branched lower alkyl group of 1 to 5 carbon atoms, and specific examples include a methyl group, ethyl group, propyl group, isopropyl group, n-butyl group, isobutyl group, tert-butyl group, pentyl group, isopentyl group and neopentyl group. Of these groups, the case in which R² and R³ are both methyl groups is preferred from an industrial viewpoint.

In the structural unit represented by the aforementioned general formula (III), the group R¹ of the structural unit represented by the above general formula (I) has been substituted with a methyl group. This type of structural unit has a lower acid dissociability than either the structural unit represented by the general formula (I) or the structural unit represented by the general formula (II).

The structural unit represented by the aforementioned general formula (IV) has a tert-butyl group bonded to the oxygen atom (—O—) of a separate ester group from the ester of the (meth)acrylate structural unit, and the (meth)acrylate ester structural unit and the separate ester group are linked together via a cyclic skeleton such as a tetracyclododecanyl group.

In the formula, the —COOC(CH₃)₃ group may be bonded to either position 3 or 4 of the tetracyclododecanyl group shown in the formula, although a mixture of both stereoisomers results, and so the bonding position cannot be further specified.

The carboxyl group residue of the (meth)acrylate structural unit may be bonded to either position 8 or 9 of the tetracyclododecanyl group, although similarly, a mixture of both stereoisomers results, and so the bonding position cannot be further specified.

Of the units described above, a combination in which a unit of the general formula (I) is used as the structural unit (a1), and a unit of the general formula (III) is used as the structural unit (a2) is preferred, and either a copolymer containing both of these units, or a mixture of two or more resins containing the respective units may be used.

The proportion of the structural unit (a1) within the combined total of the structural unit (a1) and the structural unit (a2) is preferably within a range from 40 to 90 mol %, and is even more preferably from 50 to 85 mol %.

By ensuring that this proportion is at least 40 mol %, superior contrast and a higher resolution can be achieved, whereas by ensuring the proportion is no more than 90 mol %, a superior depth of focus and a superior reduction in the proximity effect can be obtained.

The combination of the structural unit (a1) and the structural unit (a2) typically accounts for 30 to 60 mol %, and preferably from 40 to 55 mol %, of the combined total of all the structural units that constitute the component (A). By ensuring that the quantity is at least as large as the lower limit of this range, the solubility of the polymer can be more readily altered by the action of acid when the polymer is used as a positive resist composition. If the quantity exceeds the upper limit of the above range, then there is a danger that it may become impossible to achieve a suitable balance with the other structural units.

Structural Unit (a3)

The structural unit (a3) contains a lactone functional group and is derived from a (meth)acrylate ester. When used within a positive resist composition, a lactone functional group contributes to an improvement in the adhesion between the resist film and the substrate, and an increase in the hydrophilicity relative to the developing solution.

Examples of lactone functional groups include lactone-containing monocyclic groups such as a group in which one hydrogen atom has been removed from γ-butyrolactone, and lactone-containing polycyclic groups such as groups in which one hydrogen atom has been removed from the lactone-containing bicycloalkanes of the structural formulas shown below.

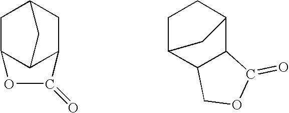

In addition, the lactone-containing monocyclic or polycyclic group is preferably one or more groups selected from the general formulas shown below.

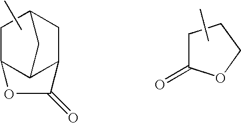

More specifically, structural units derived from a (meth)acrylate ester containing a lactone-containing monocycloalkyl group or bicycloalkyl group, as represented by the structural formulas shown below, are particularly preferred. 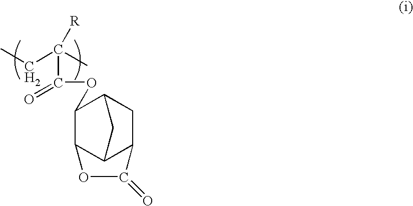
(wherein, R is as defined above) 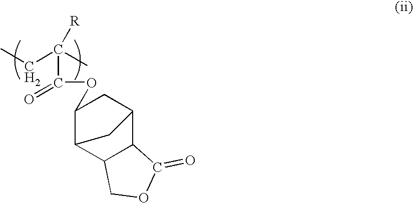
(wherein, R is as defined above) 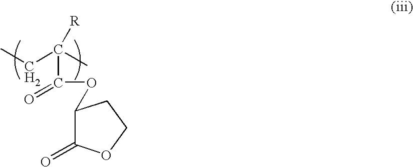
(wherein, R is as defined above)

Of these units, γ-butyrolactone esters or norbornane lactone esters of (meth)acrylic acid with an ester linkage at the α-carbon atom are particularly preferred in terms of industrial availability.

The structural unit (a3) preferably accounts for 20 to 60 mol %, and even more preferably from 30 to 50 mol %, of the combined total of all the structural units that constitute the component (A). If the quantity is smaller than the lower limit of this range, the resolution deteriorates, whereas if the quantity exceeds the upper limit, there is a danger that the resin may become difficult to dissolve in the resist solvent.

Other Structural Units

In addition to the structural units (a1) through (a3), the component (A) of the present invention may also include other structural units.

Examples of these other structural units include a structural unit (a4) with a hydroxyl group, or a structural unit (a5) that is different from all of the structural units (a1) through (a4).

Structural Unit (a4)

Because a hydroxyl group is a polar group, incorporating a structural unit (a4) containing a hydroxyl group within the component (A) improves the affinity between the component (A) and the alkali developing solution used during formation of a resist pattern. Consequently, when the component (A) is used within a positive resist composition, the alkali solubility of the exposed portions improves, which contributes to a favorable improvement in the resolution.

As the structural unit (a4), a structural unit that contains a hydroxyl group and is derived from a (meth)acrylate ester is preferred, and this structural unit can be appropriately selected from the multitude of structural units proposed for resins for use within ArF excimer laser resist compositions.

Furthermore, a structural unit which contains a hydroxyl group-containing aliphatic polycyclic group, and is derived from a (meth)acrylate ester is even more desirable. This polycyclic group can be appropriately selected from the same multitude of polycyclic groups described above in relation to the structural units (a1) and (a2).

Specifically, as the structural unit (a4), hydroxyl group-containing adamantyl groups (in which the number of hydroxyl groups is preferably from 1 to 3, and is most preferably 1), or carboxyl group-containing tetracyclododecanyl groups (in which the number of carboxyl groups is preferably from 1 to 3, and is most preferably 1) can be favorably used.

Even more specifically, using a structural unit represented by a general formula (V) shown below increases the dry etching resistance and improves the verticalness of the cross-sectional shape of the resist pattern when the component (A) is used within a positive resist composition, and is consequently preferred. 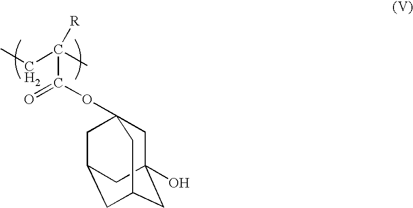
(wherein, R represents a hydrogen atom or a methyl group)

Furthermore, using a structural unit represented by a general formula (VI) shown below also increases the dry etching resistance and improves the verticalness of the cross-sectional shape of the resist pattern when the polymer is used within a positive resist composition, and is consequently preferred. 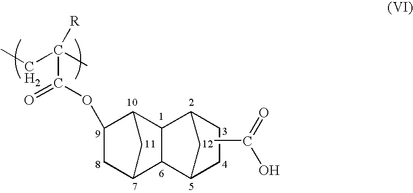
(wherein, R represents a hydrogen atom or a methyl group)

In the general formula (VI), the group —COOH may be bonded to either position 3 or 4 of the tetracyclododecanyl group shown in the formula, although a mixture of both stereoisomers results, and so the bonding position cannot be further specified. Furthermore, the carboxyl group residue of the (meth)acrylate structural unit may be bonded to either position 8 or 9 of the tetracyclododecanyl group, although similarly, a mixture of both stereoisomers results, and so the bonding position cannot be further specified.

The structural unit (a4) is not an essential component of the component (A), but when incorporated within the component (A), typically accounts for 5 to 50 mol %, and preferably from 10 to 40 mol %, of the combined total of all the structural units that constitute the component (A). By ensuring this quantity is at least as large as the lower limit of this range, the improvement in LER (line edge roughness) is particularly favorable, whereas if the quantity exceeds the upper limit of the above range, then there is a danger that a lack of balance with the other structural units may cause a deterioration in the resist pattern shape.

Structural Unit (a5)

There are no particular restrictions on the structural unit (a5), provided it is a different structural unit that cannot be classified as any of the above structural units (a1) through (a4). In other words, any structural unit that contains no acid dissociable, dissolution inhibiting groups, lactones, or hydroxyl groups is suitable. For example, structural units containing an aliphatic polycyclic group and derived from a (meth)acrylate ester are preferred. If this type of structural unit is used, then when the polymer is used within a positive resist composition, the composition exhibits superior resolution for isolated patterns through to semi-dense patterns (line and space patterns in which for a line width of 1, the space width is from 1.2 to 2), which is preferred.

Suitable examples of the polycyclic group include similar groups to those listed in the above description for the structural units (a1) and (a2), and any of the multitude of materials conventionally used for ArF positive resist materials can be used.

From the viewpoint of industrial availability, one or more groups selected from amongst tricyclodecanyl groups, adamantyl groups, and tetracyclododecanyl groups is preferred.

Specific examples of the structural unit (a5) are shown below in general formulas (VII), (VIII), and (IX). 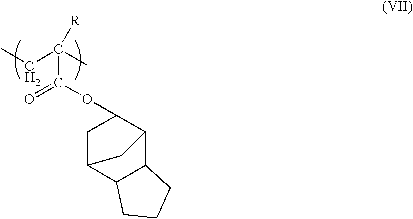
(wherein, R represents a hydrogen atom or a methyl group) 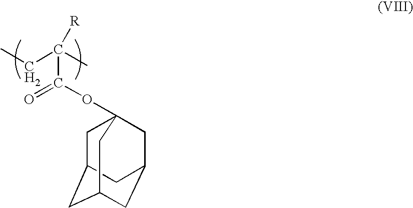
(wherein, R represents a hydrogen atom or a methyl group) 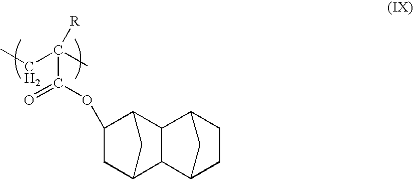
(wherein, R represents a hydrogen atom or a methyl group)

The structural unit (a5) is not an essential component of the component (A), but when incorporated within the component (A), typically accounts for 1 to 30 mol %, and preferably from 10 to 20 mol %, of the combined total of all the structural units that constitute the component (A), as such quantities exhibit superior resolution for isolated patterns through to semi-dense patterns, which is desirable.

Configuration of Component (A)

There are no particular restrictions on the configuration of the component (A), provided it contains the structural unit (a1), the structural unit (a2), and the structural unit (a3).

The component (A) may include either (i) a copolymer (A1) that contains at least the structural unit (a1) and the structural unit (a2), or (ii) a mixed resin (A2) containing a polymer that contains at least the structural unit (a1), and a polymer that contains at least the structural unit (a2).

(i): The aforementioned copolymer (A1) may also contain a structural unit (a3) in addition to the structural unit (a1) and the structural unit (a2), or alternatively, a polymer that contains the structural unit (a3) may be prepared separately, and then mixed with the copolymer (A1).

Copolymerizing the structural unit (a1), the structural unit (a2), and the structural unit (a3) yields a more favorable adhesion between the resist film and the substrate, and is consequently preferred.

(ii): In the aforementioned mixed resin (A2), at least one of the polymer that contains the structural unit (a1) and the polymer that contains the structural unit (a2) may be a copolymer that also contains the structural unit (a3). Using a copolymer that contains the structural unit (a1) and the structural unit (a3), and a copolymer that contains the structural unit (a2) and the structural unit (a3) yields a more favorable adhesion between the resist film and the substrate, and is consequently preferred.

In those cases where a structural unit (a4) and/or a structural unit (a5) is incorporated within the component (A), the structural units (a4) and/or (a5) may be copolymerized with the other structural units, or a polymer or copolymer that contains the structural units (a4) and/or (a5) may be prepared separately from the polymer or copolymer containing the other structural units, and the two polymers or copolymers then mixed together.

Of the various possible configurations, in the case of a component (A) that includes four units, namely, the structural units (a1), (a2), (a3), and either (a4) or (a5), the component (A) preferably includes either one, or a combination of, the following configurations:

a terpolymer of (a1), (a3), and (a4),

a terpolymer of (a2), (a3), and (a4),

a terpolymer of (a1), (a3), and (a5),

a terpolymer of (a2), (a3), and (a5),

a tetrapolymer of (a1), (a2), (a3), and (a4),

a tetrapolymer of (a1), (a2), (a3), and (a5),

a tetrapolymer of (a1), (a3), (a4), and (a5), and

a tetrapolymer of (a2), (a3), (a4), and (a5).

In these types of cases, where the component (A) contains either three or four units, a copolymer that contains a stable proportion of each of the units can be more readily obtained, meaning either these copolymers, or mixtures thereof can be used.

In those cases where the component (A) contains all five units, namely (a1), (a2), (a3), (a4), and (a5), a pentapolymer may be used, although obtaining a copolymer with stable proportions of each of the units is difficult, and consequently a mixed resin is preferred. In such cases, configurations such as a mixture of a tetrapolymer containing (a1), (a2), (a3) and (a4), and a tetrapolymer containing (a1), (a2), (a3) and (a5), or a mixture of a tetrapolymer containing (a1), (a3), (a4) and (a5), and a tetrapolymer containing (a2), (a3), (a4) and (a5) can be used.

When a mixture is used, mixing can be conducted so that the proportions of the various units fall within the aforementioned ranges for the component (A).

As the structural units of the component (A), the structural unit (a4) and/or the structural unit (a5) can be selected and combined with the structural units (a1), (a2), and (a3) in accordance with factors such as the intended application, although the component (A) preferably also contains a structural unit (a4).

In the case of a four unit system that includes a structural unit (a4), setting the quantity of the structural unit (a1) to 10 to 55 mol %, and preferably from 30 to 50 mol %, of the total of all the structural units, the quantity of the structural unit (a2) to 5 to 50 mol %, and preferably from 10 to 30 mol %, of the total of all the structural units, the quantity of the structural unit (a3) to 20 to 60 mol %, and preferably from 30 to 50 mol %, of the total of all the structural units, and the quantity of the structural unit (a4) to 10 to 40 mol %, and preferably from 10 to 30 mol %, of the total of all the structural units, enables the formation of a resin with favorable solubility in the resist solvent and excellent resolution, and is consequently preferred.

In the case of a five unit system that also includes a structural unit (a5), by including, within the four unit system described above, a quantity of the structural unit (a5) equivalent to 1 to 30 mol %, and preferably from 2 to 20 mol %, of the total of all the structural units, the aforementioned properties can be retained, and a resin with excellent resolution for isolated patterns and semi-dense patterns can be obtained, which is very desirable.

Although there are no particular restrictions on the weight average molecular weight of the copolymer (A1) or the polymers or copolymers that constitute the mixed resin (A2) of the component (A), these values are preferably within a range from 5,000 to 30,000, and even more preferably from 7,000 to 20,000. If the weight average molecular weight is larger than this range, the solubility within the resist solvent deteriorates, whereas if the value is smaller than the above range, there is a danger of a deterioration in the cross-sectional shape of the resist pattern.

The polymers or copolymers that constitute the copolymer (A1) or mixed resin (A2) can be produced easily by conventional radical polymerizations or the like of the corresponding (meth)acrylate ester monomers, using a radical polymerization initiator such as azobisisobutyronitrile (AIBN).

The monomers corresponding with the above structural units (a1) through (a5) are readily available as commercial products.

Component (B)

As the component (B), a compound appropriately selected from known materials used as acid generators in conventional chemically amplified resists can be used.

Examples of suitable acid generators include onium salts such as diphenyliodonium trifluoromethanesulfonate, (4-methoxyphenyl)phenyliodonium trifluoromethanesulfonate, bis(p-tert-butylphenyl)iodonium trifluoromethanesulfonate, triphenylsulfonium trifluoromethanesulfonate, (4-methoxyphenyl)diphenylsulfonium trifluoromethanesulfonate, (4-methylphenyl)diphenylsulfonium nonafluorobutanesulfonate, (p-tert-butylphenyl)diphenylsulfonium trifluoromethanesulfonate, diphenyliodonium nonafluorobutanesulfonate, bis(p-tert-butylphenyl)iodonium nonafluorobutanesulfonate, and triphenylsulfonium nonafluorobutanesulfonate. Of these compounds, onium salts containing a fluorinated alkylsulfonate ion as the anion are preferred, and sulfonium salts containing a fluorinated alkylsulfonate ion as the anion are particularly desirable.

The component (B) can be used either alone, or in combinations of two or more different compounds.

The blend quantity of the component (B) is typically within a range from 0.5 to 30 parts by weight, and preferably from 1 to 10 parts by weight, per 100 parts by weight of the component (A). Ensuring the quantity is at least 0.5 parts by weight enables pattern formation to proceed satisfactorily, whereas restricting the quantity to no more than 30 parts by weight tends to enable a more uniform solution to be obtained, thus improving the storage stability.

Component (C)

A positive resist composition can be produced by dissolving the aforementioned component (A) and the component (B), together with an optional component (D) described below, preferably in a component (C). There are no particular restrictions on the quantity of the component (C) used within the positive resist composition, which can be set, for example, to ensure a concentration that enables favorable application of the positive resist composition to the surface of a substrate or the like.

The component (C) may be any solvent capable of dissolving the component (A) and the component (B) to generate a uniform solution, and one or more solvents selected from known organic solvents used as the solvent for conventional chemically amplified resists can be used.

Specific examples of the solvent include ketones such as acetone, methyl ethyl ketone, cyclohexanone, methyl isoamyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate; cyclic ethers such as dioxane; and esters such as methyl lactate, ethyl lactate, methyl acetate, ethyl acetate, butyl acetate, methyl pyruvate, ethyl pyruvate, methyl methoxypropionate, and ethyl ethoxypropionate. These organic solvents can be used alone, or as a mixed solvent of two or more different solvents.

In particular, mixed solvents of propylene glycol monomethyl ether acetate (PGMEA) and a polar solvent containing a hydroxyl group or a lactone functional group such as propylene glycol monomethyl ether (PGME), ethyl lactate (EL) or γ-butyrolactone improve the storage stability of the positive resist composition, and are consequently preferred.

In those cases where EL is added, the weight ratio of PGMEA:EL is preferably within a range from 6:4 to 4:6.

In those cases where PGME is added, the weight ratio of PGMEA:PGME is typically within a range from 8:2 to 2:8, and preferably from 8:2 to 5:5.

As the organic solvent (C), mixed solvents containing at least one of PGMEA and ethyl lactate, together with γ-butyrolactone, are also preferred. In such cases, the weight ratio of the former and latter components in the mixed solvent is preferably within a range from 70:30 to 95:5. There are no particular restrictions on the quantity used of the organic solvent (C), although the quantity should provide a concentration that enables application of the composition to a substrate or the like. For example, the quantity of organic solvent (C) is preferably adjusted so that the solid fraction (the portion that remains as a solid when the solvent (C) is removed) within the positive resist composition of the present invention falls within a range from 2 to 20% by weight, and even more preferably from 3 to 15% by weight.

Component (D)

In the positive resist composition, in order to improve properties such as the resist pattern shape and the post exposure stability of the latent image formed by the pattern-wise exposure of the resist layer, an amine, and preferably a secondary lower aliphatic amine or a tertiary lower aliphatic amine, can also be added as an optional component (D).

Here, a lower aliphatic amine refers to an alkyl or alkyl alcohol amine of no more than 5 carbon atoms, and examples of these secondary and tertiary amines include trimethylamine, diethylamine, triethylamine, di-n-propylamine, tri-n-propylamine, tripentylamine, diethanolamine and triethanolamine, and alkanolamines such as triethanolamine are particularly preferred.

These may be used alone, or in combinations of two or more different compounds.

This amine is typically added in a quantity within a range from 0.01 to 2 parts by weight per 100 parts by weight of the component (A).

(E) Organic carboxylic acid, or phosphorus oxo acid or derivative thereof.

In the positive resist composition, in order to improve the resist pattern shape and the post exposure stability of the latent image formed by the pattern-wise exposure of the resist layer in a similar manner to the above component (D), an organic carboxylic acid, or a phosphorus oxo acid or derivative thereof can also be added as another optional component (E). The component (D) and the component (E) can be used in combination, or either one may also be used alone.

Examples of suitable organic carboxylic acids include malonic acid, citric acid, malic acid, succinic acid, benzoic acid, and salicylic acid.

Examples of suitable phosphorus oxo acids or derivatives thereof include phosphoric acid or derivatives thereof such as esters, including phosphoric acid, di-n-butyl phosphate and diphenyl phosphate; phosphonic acid or derivatives thereof such as esters, including phosphonic acid, dimethyl phosphonate, di-n-butyl phosphonate, phenylphosphonic acid, diphenyl phosphonate, and dibenzyl phosphonate; and phosphinic acid or derivatives thereof such as esters, including phosphinic acid and phenylphosphinic acid, and of these, phosphonic acid is particularly preferred.

The component (E) is typically used in a quantity within a range from 0.01 to 5 parts by weight per 100 parts by weight of the component (A).

Miscible additives can also be added to the positive resist composition according to need, including additive resins for improving the properties of the resist film, surfactants for improving the ease of application, dissolution inhibitors, plasticizers, stabilizers, colorants and halation prevention agents.

This positive resist composition exhibits excellent transparency relative to wavelengths of 200 nm or shorter, and is consequently particularly useful as the positive resist composition for an ArF excimer laser, but is also useful as a resist for even shorter wavelength sources such as F₂ lasers, and other radiation such as EUV (Extreme Ultra Violet), VUV (vacuum ultraviolet), electron beams, X-rays, and soft X-rays.

This positive resist composition includes two or more acid dissociable, dissolution inhibiting groups with different levels of acid dissociability in the resin component (A), and by using a positive resist composition that contains such a resin component (A), the proximity effect can be reduced without reducing the depth of focus. In cases that include isolated patterns such as those described in the following examples, the invention enables the depth of focus to be increased, while the proximity effect is reduced.

In this positive resist composition, because the resin component (A) also includes a structural unit (a3) that contains a lactone functional group, in addition to the structural units (a1) and (a2) that contain different acid dissociable, dissolution inhibiting groups with different levels of acid dissociability, not only is an improvement in hydrophilicity obtained as a result of the lactone functional group, but the depth of focus of isolated patterns can also be improved.

[Method of Forming a Resist Pattern (Production Method)]

A method of forming a resist pattern according to the present invention can be conducted, for example, in the manner described below.

Namely, a positive resist composition described above is first applied to the surface of a substrate such as a silicon wafer using a spinner or the like, a prebake is conducted under temperature conditions of 80 to 150° C. for 40 to 120 seconds, and preferably for 60 to 90 seconds, and following selective exposure of the applied resist with an ArF exposure apparatus or the like, by irradiating ArF excimer laser light through a desired mask pattern, PEB (post exposure baking) is conducted.

Subsequently, developing is conducted using an alkali developing solution such as a 0.1 to 10% by weight aqueous solution of tetramethylammonium hydroxide, thereby yielding a resist pattern in which the shape of the mask pattern has been transferred to the resist.

An organic or inorganic anti-reflective film may also be provided between the substrate and the applied layer of the resist composition.

The heating temperature used during the PEB treatment is preferably equal to or higher than the lower limit of the temperature range across which the acid dissociable, dissolution inhibiting group contained within the aforementioned structural unit (a1) of the component (A) undergoes dissociation (hereafter, this temperature is referred to as PEBmin), but less than the lower limit of the temperature range across which the acid dissociable, dissolution inhibiting group contained within the aforementioned structural unit (a2) undergoes dissociation (hereafter, this temperature is referred to as PEBmax).

At PEBmin, although almost all of the acid dissociable, dissolution inhibiting groups contained within the structural units (a1) dissociate, total dissociation does not occur, and at PEBmax, a small proportion of the acid dissociable, dissolution inhibiting groups contained within the structural units (a2) dissociate, meaning there is not a complete lack of dissociation.

Accordingly, the expression “the acid dissociable, dissolution inhibiting group contained within the structural unit (a1) dissociates” does not imply 100% dissociation. Similarly, a temperature that is “less than the lower limit of the temperature range across which the acid dissociable, dissolution inhibiting group contained within the aforementioned structural unit (a2) undergoes dissociation” does not imply that dissociation of the acid dissociable, dissolution inhibiting group contained within the structural unit (a2) is at 0%.

The present invention includes the structural units (a1) and (a2) as acid dissociable, dissolution inhibiting groups, and of these, the unit (a1) must undergo almost complete dissociation and the unit (a2) very little dissociation, but that does not mean that the acid dissociable, dissolution inhibiting groups of the units (a1) must undergo 100% dissociation while the acid dissociable, dissolution inhibiting groups of the units (a2) undergo absolutely no dissociation.

Accordingly, PEBmin is typically within a range from approximately 90 to 130° C., and PEBmax is typically from 110 to 140° C., and in light of the comments above, the temperature for the PEB treatment in the present invention is preferably within a range from approximately 90 to 125° C., and even more preferably from 90 to 120° C. The acid dissociable, dissolution inhibiting group contained within the structural unit (a1) dissociates more readily than the acid dissociable, dissolution inhibiting group contained within the structural unit (a2), and consequently the lower limit of the temperature range across which the acid dissociable, dissolution inhibiting group contained within the structural unit (a1) undergoes dissociation is lower than the lower limit of the temperature range across which the acid dissociable, dissolution inhibiting group contained within the structural unit (a2) undergoes dissociation.

In the case of a chemically amplified positive resist composition, a dissociation reaction of the acid dissociable, dissolution inhibiting groups occurs during PEB, and because the level of alkali solubility is determined on the basis of the extent of this dissociation reaction, the heating conditions are preferably set to a temperature within the above range that ensures a favorable resist pattern profile for the pattern formed following developing treatment.

If the heating temperature during PEB is lower than the lower limit of the temperature range across which the acid dissociable, dissolution inhibiting group contained within the structural unit (a1) undergoes dissociation, then the alkali solubility of the resist is inadequate and a favorable resolution cannot be achieved, whereas if the heating temperature is higher than the lower limit of the temperature range across which the acid dissociable, dissolution inhibiting group contained within the structural unit (a2) undergoes dissociation, then the advantages of incorporating two or more acid dissociable, dissolution inhibiting groups with different acid dissociability into the resin component (A), namely, reducing the proximity effect without reducing the depth of focus, or even increasing the depth of focus while reducing the proximity effect, are unable to be realized satisfactorily.

The temperature range across which an acid dissociable, dissolution inhibiting group dissociates varies depending on the structure of the acid dissociable, dissolution inhibiting group, and also on the structure of those portions of the structural unit (a1) or (a2) outside the acid dissociable, dissolution inhibiting group, although in the case of a resist composition, the temperature ranges are fairly well determined.

For example, the temperature range across which the acid dissociable, dissolution inhibiting group contained within the structural unit (a1) dissociates (hereafter also referred to as the “acid dissociation temperature range”):

is from 90 to 120° C. in those cases where in the aforementioned general formula (I), R represents a hydrogen atom and R¹ represents an ethyl group,

is from 100 to 130° C. in those cases where in the general formula (I), R represents a methyl group and R¹ represents an ethyl group,

is from 90 to 120° C. in those cases where in the aforementioned general formula (II), R represents a hydrogen atom, and R² and R³ both represent methyl groups, and

is from 100 to 130° C. in those cases where in the general formula (II), R represents a methyl group, and R² and R³ both represent methyl groups,

The temperature range across which the acid dissociable, dissolution inhibiting group contained within the structural unit (a2) dissociates:

is from 100 to 130° C. in those cases where in the aforementioned general formula (III), R represents a hydrogen atom,

is from 110 to 140° C. in those cases where in the general formula (III), R represents a methyl group,

is from 100 to 130° C. in those cases where in the aforementioned general formula (IV), R represents a hydrogen atom, and

is from 110 to 140° C. in those cases where in the general formula (IV), R represents a methyl group.

### EXAMPLES

As follows is a more detailed description of the present invention, based on a series of examples.

### Example 1

The components (A) to (D) described below were mixed together and dissolved to prepare a positive resist composition.

Component (A): 100 parts by weight of a copolymer (weight average molecular weight: 10,000, polydispersity: 2.0) produced by copolymerization of the monomers below:

2-ethyl-2-adamantyl acrylate: 40 mol % (corresponds with the structural unit (a1)),

2-methyl-2-adamantyl acrylate: 10 mol % (corresponds with the structural unit (a2)),

norbornane lactone acrylate (hereafter abbreviated as N lactone): 30 mol % (corresponds with the structural unit (a3), and generates the structural unit of the general formula (i) wherein R is a hydrogen atom), and

3-hydroxy-1-adamantyl acrylate (hereafter abbreviated as ADOH): 20 mol % (corresponds with the structural unit (a4), and generates the structural unit of the general formula (V) wherein R is a hydrogen atom).

Component (B): 3.0 parts by weight of triphenylsulfonium nonafluorobutanesulfonate.

Component (C): a mixed solvent containing 750 parts by weight of PGMEA and 30 parts by weight of γ-butyrolactone.

Component (D): 0.1 parts by weight of triethanolamine.

Subsequently, this positive type resist composition was applied to the surface of a silicon wafer using a spinner, prebaked (PAB treatment) for 90 seconds at 110° C. on a hotplate, and then dried to form a resist layer with a film thickness of 400 nm.

This film was then selectively irradiated with an ArF excimer laser (193 nm) through a half-tone mask pattern, using an ArF exposure apparatus NSR-S302A (manufactured by Nikon Corporation, NA (numerical aperture)=0.60, σ=0.75).

The film was then subjected to PEB treatment at 100° C. for 90 seconds, subsequently subjected to puddle development for 60 seconds at 23° C. in a 2.38% by weight aqueous solution of tetramethylammonium hydroxide, and was then washed for 20 seconds with water, and dried, thereby completing formation of a resist pattern.

The thus formed contact hole pattern of width 140 nm included both a dense type pattern with a pattern spacing of 1:1.4, and an Iso type pattern with a pattern spacing of 1:10.

The depth of focus (abbreviated as DOF within the table, this also applies below) within the dense pattern was 400 nm, and the depth of focus within the Iso pattern was 300 nm.

In order to evaluate the proximity effect, the exposure dose was fixed at the level required to produce a resist pattern width following developing of 140 nm within the Iso pattern, and 140 nm was then subtracted from the developed pattern width within the dense pattern produced at the same exposure dose (namely, the I/D dimensional difference), yielding a result of 18 nm. Smaller values for this I/D dimensional difference indicate a smaller proximity effect, and are consequently preferred.

The results are summarized below in Table 1.

The ideal PEB temperature for the resist using the copolymer from this example was from 90 to 110° C.

### Example 2

With the exception of altering the component (A), a positive resist composition was produced in the same manner as the example 1. The components (B) through (D) were the same as those described for the example 1.

Component (A): 80 parts by weight of a first copolymer (weight average molecular weight: 10,000, polydispersity: 2.0) produced by copolymerization of the monomers below:

2-ethyl-2-adamantyl acrylate: 50 mol % (corresponds with the structural unit (a1)),

N lactone: 30 mol % (corresponds with the structural unit (a3)), and

ADOH: 20 mol % (corresponds with the structural unit (a4)),

was mixed with 20 parts by weight of a second copolymer (weight average molecular weight: 10,000, polydispersity: 2.0) produced by copolymerization of the monomers below:

2-methyl-2-adamantyl acrylate: 50 mol % (corresponds with the structural unit (a2)),

N lactone: 30 mol % (corresponds with the structural unit (a3)), and

ADOH: 20 mol % (corresponds with the structural unit (a4)), thereby yielding 100 parts by weight of a mixed resin that was used as the component (A).

Using the thus obtained positive resist composition, a contact hole pattern was formed using the same production conditions as those described in the example 1.

The depth of focus within the dense pattern was 400 nm, and the depth of focus within the Iso pattern was 300 nm. The I/D dimensional difference was 20 nm.

The results are summarized below in Table 1.

The ideal PEB temperature for the resist using the copolymer from this example was from 90 to 110° C.

### Comparative Example 1

With the exception of altering the component (A), a positive resist composition was produced in the same manner as the example 1. The components (B) through (D) were the same as those described for the example 1.

Component (A): 100 parts by weight of a copolymer (weight average molecular weight: 10,000, polydispersity: 2.0) produced by copolymerization of the monomers below:

2-methyl-2-adamantyl acrylate: 50 mol % (corresponds with the structural unit (a2)),

N lactone: 30 mol % (corresponds with the structural unit (a3)), and

ADOH: 20 mol % (corresponds with the structural unit (a4)).

Using the thus obtained positive resist composition, an attempt was made to form a resist pattern using the same production conditions as those described in the example 1, but neither the dense pattern nor the Iso pattern could be resolved.

### Comparative Example 2

With the exceptions of altering the PAB treatment temperature to 130° C. and altering the PEB treatment temperature to 120° C., production in the same manner as the comparative example 1 enabled formation of a resist pattern.

The depth of focus within the dense pattern was 300 nm, and the depth of focus within the Iso pattern was 100 nm. The I/D dimensional difference was 26 nm.

The results are summarized below in Table 1.

### Comparative Example 3

With the exception of altering the component (A), a positive resist composition was produced in the same manner as the example 1. The components (B) through (D) were the same as those described for the example 1.

Component (A): 100 parts by weight of a copolymer (weight average molecular weight: 10,000, polydispersity: 2.0) produced by copolymerization of the monomers below:

2-ethyl-2-adamantyl acrylate: 50 mol % (corresponds with the structural unit (a1)),

N lactone: 30 mol % (corresponds with the structural unit (a3)), and

ADOH: 20 mol % (corresponds with the structural unit (a4)).

Using the thus obtained positive resist composition, a contact hole pattern was formed using the same production conditions as those described in the example 1.

The depth of focus within the dense pattern was 400 nm, and the depth of focus within the Iso pattern was 200 nm. The I/D dimensional difference was 30 nm.

The results are summarized below in Table 1.

TABLE 1

| | PAB heating | | | |
|---|---|---|---|---|
| | temperature/ | | | I/D |
| | PEN heating | DOF | DOF | dimensional |
| | temperature | (dense) | (Iso) | difference |
| Example 1 | 110/100 | 400 nm | 300 nm | 18 nm |
| Example 2 | 110/100 | 400 nm | 300 nm | 20 nm |
| Comparative | 110/100 | unresolvable | unresolvable | |
| example 1 | | | | |
| Comparative | 130/120 | 300 nm | 100 nm | 26 nm |
| example 2 | | | | |
| Comparative | 110/110 | 400 nm | 200 nm | 30 nm |
| example 3 | | | | |

### Example 3

The components (A) to (D) described below were mixed together and dissolved to prepare a positive resist composition.

Component (A): 100 parts by weight of a copolymer (weight average molecular weight: 10,000, polydispersity: 2.0) produced by copolymerization of the monomers below:

2-ethyl-2-adamantyl methacrylate: 20 mol % (corresponds with the structural unit (a1)),

2-methyl-2-adamantyl methacrylate: 15 mol % (corresponds with the structural unit (a2)),

γ-butyrolactone acrylate (hereafter abbreviated as γ lactone): 35 mol % (corresponds with the structural unit (a3), and generates the structural unit of the general formula (iii) wherein R is a hydrogen atom),

ADOH: 15 mol % (corresponds with the structural unit (a4)), and

tricyclodecanyl methacrylate (hereafter abbreviated as TCD): 15 mol % (corresponds with the structural unit (a5), and generates the structural unit of the general formula (VII) wherein R is a methyl group).

Component (B): 3.0 parts by weight of triphenylsulfonium nonafluorobutanesulfonate.

Component (C): a mixed solvent containing 750 parts by weight of PGMEA and 30 parts by weight of γ-butyrolactone.

Component (D): 0.2 parts by weight of triethanolamine.

Subsequently, this positive type resist composition was applied to the surface of a silicon wafer using a spinner, prebaked (PAB treatment) for 90 seconds at 110° C. on a hotplate, and then dried to form a resist layer with a film thickness of 300 nm.

This film was then selectively irradiated with an ArF excimer laser (193 nm) through a mask pattern, using an ArF exposure apparatus NSR-S302A (manufactured by Nikon Corporation, NA (numerical aperture)=0.60, σ=0.75).

The film was then subjected to PEB treatment at 110° C. for 90 seconds, subsequently subjected to puddle development for 60 seconds at 23° C. in a 2.38% by weight aqueous solution of tetramethylammonium hydroxide, and was then washed for 20 seconds with water, and dried, thereby completing formation of a resist pattern.

The thus formed line and space pattern of width 120 nm included both a dense type pattern with a pattern spacing of 1:1, and an Iso type pattern with a pattern spacing of 1:10.

The depth of focus within the dense pattern was 800 nm, and the depth of focus within the Iso pattern was 500 nm.

In order to evaluate the proximity effect, the exposure dose was fixed at the level required to produce a resist pattern width following developing of 120 nm within the Iso pattern, and 120 nm was then subtracted from the developed pattern width within the dense pattern produced at the same exposure dose (namely, the I/D dimensional difference), yielding a result of 21 nm.

The results are summarized below in Table 2.

The ideal PEB temperature for the resist using the copolymer from this example was from 100 to 120° C.

### Comparative Example 4

With the exceptions of altering the component (A), and changing the blend quantity of the component (B) to 2 parts by weight, a positive resist composition was produced in the same manner as the example 3. The components (C) and (D) were the same as those described for the example 3.

Component (A): 100 parts by weight of a copolymer (weight average molecular weight: 10,000, polydispersity: 2.0) produced by copolymerization of the monomers below:

2-methyl-2-adamantyl acrylate: 35 mol % (corresponds with the structural unit (a2)),

γ lactone: 35 mol % (corresponds with the structural unit (a3)),

ADOH: 15 mol % (corresponds with the structural unit (a4)), and

TCD: 15 mol % (corresponds with the structural unit (a5)).

Component (B): 2.0 parts by weight of triphenylsulfonium nonafluorobutanesulfonate.

Using the thus obtained positive resist composition, an attempt was made to form a resist pattern using the same production conditions as those described in the example 3, but neither the dense pattern nor the Iso pattern could be resolved, and the dense pattern developed with a T-top shape.

### Comparative Example 5

With the exceptions of altering the PAB treatment temperature to 130° C. and altering the PEB treatment temperature to 130° C., production in the same manner as the comparative example 4 enabled formation of a resist pattern.

The depth of focus within the dense pattern was 600 nm, and the depth of focus within the Iso pattern was 400 nm. The I/D dimensional difference was 26 nm.

The results are summarized below in Table 2.

### Comparative Example 6

With the exceptions of altering the component (A), and changing the blend quantity of the component (B) to 2 parts by weight, a positive resist composition was produced in the same manner as the example 3. The components (C) and (D) were the same as those described for the example 3.

Component (A): 100 parts by weight of a copolymer (weight average molecular weight: 10,000, polydispersity: 2.0) produced by copolymerization of the monomers below:

2-ethyl-2-adamantyl methacrylate: 35 mol % (corresponds with the structural unit (a1)),

γ lactone: 35 mol % (corresponds with the structural unit (a3)),

ADOH: 15 mol % (corresponds with the structural unit (a4)), and

TCD: 15 mol % (corresponds with the structural unit (a5)).

Component (B): 2.0 parts by weight of triphenylsulfonium nonafluorobutanesulfonate.

Using the thus obtained positive resist composition, a line and space pattern was formed using the same production conditions as those described in the example 3.

The depth of focus within the dense pattern was 800 nm, and the depth of focus within the Iso pattern was 400 nm. The I/D dimensional difference was 36 nm.

The results are summarized below in Table 2.

TABLE 2

| | PAB heating | | | |
|---|---|---|---|---|
| | temperature/ | | | I/D |
| | PEN heating | DOF | DOF | dimensional |
| | temperature | (dense) | (Iso) | difference |
| Example 3 | 110/110 | 800 nm | 500 nm | 21 nm |
| Comparative | 110/110 | unresolvable | unresolvable | |
| example 4 | | | | |
| Comparative | 130/130 | 600 nm | 400 nm | 26 nm |
| example 5 | | | | |
| Comparative | 110/110 | 800 nm | 400 nm | 36 nm |
| example 6 | | | | |

From the results in Table 1 it is evident that compared with the comparative examples 2 and 3, the examples 1 and 2 provide a similar or improved depth of focus, while also offering a significant reduction in the I/D dimensional difference that is a measure of the proximity effect.

From the results in Table 2 it is evident that compared with the comparative examples 5 and 6, the example 3 provides a similar or improved depth of focus, while also offering a significant reduction in the I/D dimensional difference that is a measure of the proximity effect.

### INDUSTRIAL APPLICABILITY

As described above, the present invention provides a resist composition and a method of forming a resist pattern that enable the proximity effect to be reduced without reducing the depth of focus, and is consequently extremely useful industrially.

1. A positive resist composition, comprising:
a resin component (A) that exhibits increased alkali solubility under action of acid, said component (A) comprising
(i) a structural unit (a1), which contains an acid dissociable, dissolution inhibiting group and is derived from a (meth)acrylate ester,
(ii) a structural unit (a2), which contains an acid dissociable, dissolution inhibiting group that is less readily dissociated than said acid dissociable, dissolution inhibiting group contained in said structural unit (a1), and is derived from a (meth)acrylate ester, and
(iii) a structural unit (a3), which contains a lactone functional group and is derived from a (meth)acrylate ester,
an acid generator component (B) that generates acid on exposure, and
an organic solvent (C).

2. A positive resist composition according to claim 1, wherein
said structural unit (a1) is at least one unit selected from a general formula (I) or a general formula (II) shown below, and
said structural unit (a2) is at least one unit selected from a general formula (III) or a general formula (IV) shown below: 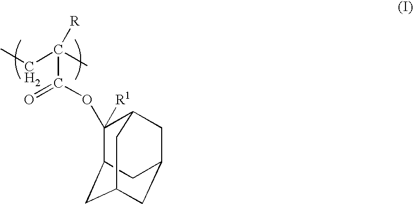
(wherein, R represents a hydrogen atom or a methyl group, and R¹ represents a lower alkyl group of 2 or more carbon atoms), 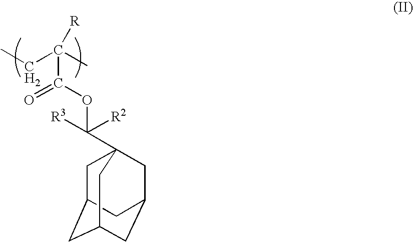
(wherein, R represents a hydrogen atom or a methyl group, and R² and R³ each represent, independently, a lower alkyl group), 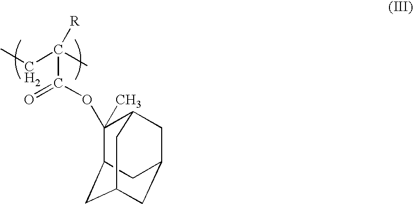
(wherein, R represents a hydrogen atom or a methyl group), and 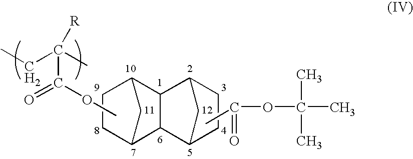
(wherein, R represents a hydrogen atom or a methyl group).

3. A positive resist composition according to claim 1, wherein a proportion of said structural unit (a1) within a combined total of said structural unit (a1) and said structural unit (a2) is within a range from 40 to 90 mol %.

4. A positive resist composition according to claim 1, wherein a combination of said structural unit (a1) and said structural unit (a2) accounts for 30 to 60 mol % of a combined total of all structural units that constitute said component (A).

5. A positive resist composition according to claim 1, wherein said structural unit (a3) accounts for 20 to 60 mol % of a combined total of all structural units that constitute said component (A).

6. A positive resist composition according to claim 1, wherein said component (A) comprises a copolymer (A1) containing at least said structural unit (a1) and said structural unit (a2).

7. A positive resist composition according to claim 6, wherein said copolymer (A1) also contains said structural unit (a3).

8. A positive resist composition according to claim 6, wherein said copolymer (A1) is mixed with a polymer containing said structural unit (a3).

9. A positive resist composition according to claim 1, wherein said component (A) comprises a mixed resin (A2) containing a polymer that contains at least said structural unit (a1), and a polymer that contains at least said structural unit (a2).

10. A positive resist composition according to claim 9, wherein at least one of said polymer that contains said structural unit (a1), and said polymer that contains said structural unit (a2) is a copolymer that also contains said structural unit (a3).

11. A positive resist composition according to claim 10, wherein both said polymer that contains said structural unit (a1), and said polymer that contains said structural unit (a2) are copolymers that also contain said structural unit (a3).

12. A positive resist composition according to claim 1, wherein said acid generator component (B) is an onium salt with a fluorinated alkylsulfonate ion as an anion.

13. A positive resist composition according to claim 1, further comprising an amine (D).

14. A method of forming a resist pattern, comprising the steps of applying a positive resist composition according to claim 1 to a substrate, conducting a prebake, performing selective exposure, conducting PEB (post exposure baking), and performing alkali developing to form a resist pattern.

15. A method of forming a resist pattern according to claim 14, wherein a heating temperature used during said PEB is equal to or higher than a lower limit of a temperature range across which an acid dissociable, dissolution inhibiting group contained within said structural unit (a1) undergoes dissociation, but is less than a lower limit of a temperature range across which an acid dissociable, dissolution inhibiting group contained within said structural unit (a2) undergoes dissociation.

16. A method of forming a resist pattern according to claim 15, wherein a heating temperature used during said PEB is within a range from 90 to 125° C.
